(19) United States
(12) Patent Application Publication
(10) Pub. No.: US 2009/0246341 A1
(43) Pub. Date: Oct. 1, 2009

(54) System and Method for Brewing Tea

(76) Inventors: James H. Pitner, Tyler, TX (US); Gary L. Kennemer, Winona, TX (US)

Correspondence Address: BAKER BOTTS L.L.P., 2001 ROSS AVENUE, SUITE 600, DALLAS, TX, 75201-2980, US

(21) Appl. No.: 12/060,579

(22) Filed: Apr. 1, 2008

(51) Int. Cl. A23F 3/16; A47J 31/24; A47J 31/00; A47J 31/08; A47J 31/44

(52) U.S. Cl. 426/435; 99/302 R; 99/288; 99/298; 99/317

(57) ABSTRACT

A method for brewing tea comprises filling a first tank with water, transferring a volume of the water from the first tank to a second tank, and heating the volume of the water in the second tank. The method further comprises placing a plurality of tea leaves in a receptacle, wherein the receptacle is in fluid communication with the second tank. Portions of the volume of water in the second tank are circulated through the receptacle, such that the portions flow over the tea leaves and return to the second tank, resulting in a brewed tea.

### TECHNICAL FIELD

The present invention relates generally to beverage preparation, and more particularly to a system and method for brewing tea.

### BACKGROUND

Tea is traditionally brewed by dipping a tea bag into heated water. This same process used for preparing a single cup of tea is also employed for the large-scale brewing of thousands of gallons of bottled ready-to-drink tea. In order to produce high quality tea, there must be adequate circulation of the heated water around and through the tea bags. Ensuring proper circulation can be problematic during large-scale brewing activities, as the tea bags may become bunched and inhibit proper fluid flow. Thus, regardless of the amount of tea being prepared, relatively small tea bags are still used.

### SUMMARY OF EXAMPLE EMBODIMENTS

The present disclosure is directed to a system and method for brewing tea. The teachings of the present disclosure may allow for more efficient brewing of tea.

In accordance with one embodiment of the present disclosure a method for brewing tea comprises filling a first tank with water, transferring a volume of the water from the first tank to a second tank, and heating the volume of the water in the second tank. A plurality of leaves is placed in a receptacle, wherein the receptacle is in fluid communication with the second tank. Portions of the volume of water in the second tank are circulated through the receptacle, wherein the portions flow over the tea leaves and return to the second tank, resulting in a brewed tea. The brewed tea is then transferred to the first tank and cooled using one or more heat exchangers. More specifically, the receptacle may comprise a perforated section to allow fluid flow therethrough and a filter paper overlapping the perforated section.

Technical advantages of particular embodiments of the present disclosure may include producing a higher yield of tea. The use of loose tea leaves may increase fluid circulation during the brewing process, increasing the yield from a given amount of tea. Additionally, bunching problems encountered when using traditional tea bags may be reduced.

Further technical advantages of particular embodiments may include a more efficient brewing process. The use of the loose tea leaves and heating and cooling methods of the present disclosure may reduce the amount of time to brew a batch of tea.

Other technical advantages of the present disclosure will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present invention and for further features and advantages thereof, reference is now made to the following description taken in conjunction with the accompanying drawings, in which:

FIG. 1 is a schematic illustration of a tea brewing system in accordance with the present invention;

FIG. 2 is a cross-sectional detail view of a brewing tank in accordance with the present invention;

FIG. 3 is a cross-sectional detail view of a brewing tank and brewing receptacle in accordance with the present invention; and

FIG. 4 is a flow diagram illustrating a method of brewing tea according to an embodiment of the present invention.

### DETAILED DESCRIPTION

Even for the large-scale production of thousands of gallons of tea, the traditional tea brewing process of dipping tea bags into hot water is typically employed. As the scale of production increases, this can lead to some complications and inefficiencies in the brewing process. In order to produce high quality tea, there must be sufficient circulation of the heated water around and through the tea leaves that are typically enclosed in multiple, small bags. Ensuring proper circulation can be problematic during large-scale brewing activities, due to the “bunching” of tea leaves and tea bags. During the brewing, tea leaves may become clustered in one particular area of a tea bag, inhibiting proper fluid flow. Circulation may also be limited by the folding or bunching up of the tea bags. Using very large tea bags can increase the likelihood of this bunching, as the larger bags are more likely to get folded over or crumpled. Thus, regardless of the amount of tea being prepared, relatively small tea bags are still typically used. It is also important that the correct temperatures be maintained at certain stages of the brewing process. These proper temperatures help ensure that the final brewed tea will have the best taste, color, and clarity.

In accordance with the teachings of the present disclosure, a method for brewing tea addresses the issues of large-scale brewing and may provide a more efficient brewing process. An object of this new method may be to provide a more efficient brewing process. The new method may additionally produce a higher yield and better quality of tea.

According to one embodiment, a method for brewing tea comprises filling a first tank with water, transferring a volume of the water from the first tank to a second tank, and heating the volume of the water in the second tank. A plurality of leaves is placed in a receptacle, wherein the receptacle is in fluid communication with the second tank. Portions of the volume of water in the second tank are circulated through the receptacle, wherein the portions flow over the tea leaves and return to the second tank, resulting in a brewed tea. The brewed tea is then transferred to the first tank and then cooled using one or more heat exchangers. More specifically, the receptacle may comprise a perforated section to allow fluid flow therethrough and a filter paper overlapping the perforated section.

While various embodiments of the present invention are discussed in detail below, it should be appreciated that the present invention provides many applicable inventive concepts which can be embodied in a wide variety of specific contexts. The specific embodiments discussed herein are merely illustrative of specific ways to make and use the invention, and do not delimit the scope of the present invention.

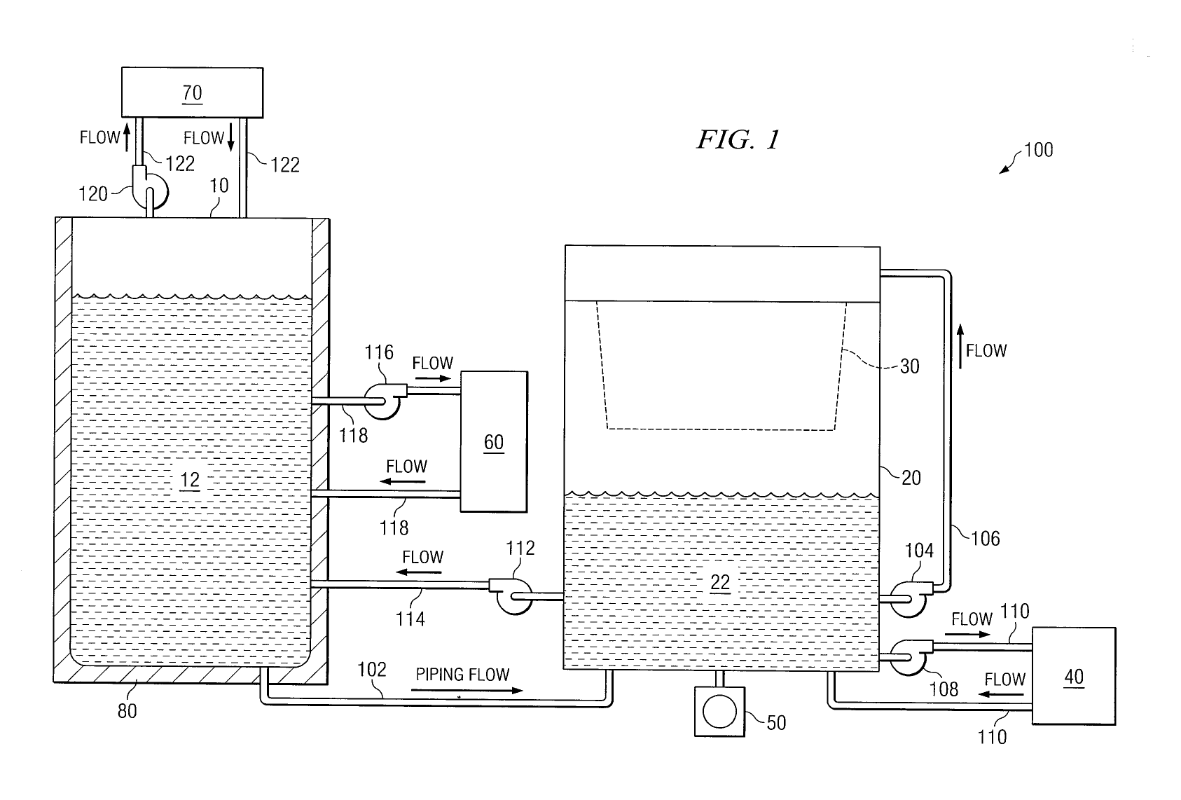

FIG. 1 illustrates a tea brewing system in accordance with the present disclosure, generally designated by reference numeral 100. System 100 includes first tank 10, second tank 20, brewing receptacle 30, heat exchanger 40, chart recorder/controller 50, heat exchanger 60, and filter 70.

First tank 10, which may be referred to as a process tank, is meant to store water, brewed tea, or any combination of the two. First tank 10 may generally be constructed of any material that provides the requisite strength and temperature control properties needed for the brewing process. In one particular embodiment, first tank 10 may be constructed of stainless steel. Additionally, first tank 10 may be constructed to hold 2500 gallons or more of a liquid, depending on the size of the brewing operation it is being used in. First tank 10 may also provide required temperature control properties for the brewing of tea. This can be accomplished through selection of the material of first tank 10, additional temperature control elements, or a combination thereof. In a particular embodiment, first tank 10 may have a cold wall system, designated by reference numeral 80. This system may include piping for the circulation of cold water through the walls of first tank 10. This circulation may allow the walls, and in turn the content of first tank 10, to be maintained at a steady temperature. According to particular embodiments, cold wall system 80 is capable of maintaining the temperature of liquids in first tank 10 at 35 degrees Fahrenheit. In other embodiments, a chill water system may also be used to chill the first tank 10. This chill water system may be any commercially available or custom designed system capable of providing the requisite cooling needs. In particular embodiments, such a system may include a three plate heat exchanger used in conjunction with chillers and/or an ice builder.

In addition to the elements used to cool the process tank, first tank 10 may also include a chart recorder/controller for recording statistics and maintaining the temperature of the process tank and the liquids inside of it. The chart recorder/controller helps provide quality control by maintaining appropriate temperatures and providing a record of every event that takes place during the brewing process regarding first tank 10.

Additional components that may be included in first tank 10 may include an agitator for mixing liquids. The agitator may include one or more propellers, impellers, paddles, or any combination thereof suitable for mixing liquids inside first tank 10. First tank 10 may also include a filtration system 70. Filtration system 70 may serve to filter and sterilize excess air contained in first tank 10. In the illustrated embodiment, filtration system 70 may be connected to first tank 10 by piping 122. Additionally, pump 120 may be employed to circulate the air from first tank 10 through filtration system 70. Filtration system 70 may include HEPA positive pressure air filtration and an ultraviolet (UV) system. First tank 10 may also include all valving and piping necessary for filling the first tank, cooling the contents of the first tank, chilling the walls of the first tank, and blending the contents of the first tank. Part of this piping may include piping 102 that connects first tank 10 to second tank 20.

The tea brewing process is begun by treating a predetermined amount of water to remove contaminants, such as chlorine or chloramine. In particular embodiments, this may be accomplished by passing the water through a five micron filter. The water is then introduced into first tank 10. After the water is introduced into the tank, the water may be cooled to a particular temperature. In certain embodiments, the water may be maintained at an ambient temperature of approximately 65 degrees Fahrenheit. Next, a volume of the water in first tank 10 is transferred to second tank 20 using piping 102. This may be accomplished using any traditional method of transferring fluid, including through the use of a pump.

Second tank 20 may be referred to as a brewing tank. Similar to first tank 10, second tank 20 may generally be constructed of any material that provides the requisite strength and temperature control properties needed for the brewing process. In one particular embodiment, second tank 20 may be constructed of a stainless steel, such as 316 stainless steel. Additionally, second tank 20 may be constructed to hold 1000 gallons or more of a liquid, depending on the size of the brewing operation it is being used in. Second tank 20 may also provide required temperature control properties for the brewing of tea. This can be accomplished through selection of the material of second tank 20, additional temperature control elements, or a combination thereof.

The water in second tank 20 may be heated before it may be brought into contact with any tea leaves. In one particular embodiment, this involves heating the water to approximately 198 degrees Fahrenheit. The heating of the water may be accomplished using various heating methods. In one particular embodiment, this may be accomplished by circulating the water through a heat exchanger 40. According to the illustrated embodiment, heat exchanger 40 is connected to second tank 20 using piping 110. Additionally, pump 108 may be employed to circulate the water from first tank 20 through heat exchanger 40. Additional heating elements, such as extra heat exchangers, a steam injection water heating system, and/or a chart controller/recorder may also be employed. These and other heating apparatuses may be incorporated within second tank 20, located externally to the second tank 20, or some combination thereof.

After all or substantially all of the water in second tank 20 has been heated to the appropriate temperature, that temperature may be maintained throughout the brewing process to enhance the quality and consistency of the final brewed tea. In particular embodiments, this is accomplished using chart recorder/controller 50. Chart recorder/controller 50 may be used to control the temperature of water and/or tea in second tank 20 through the manipulation of valves controlling the flow of water and the introduction of steam. In particular embodiments, chart recorder/controller is capable of maintaining a temperature within a range of +/−3 degrees Fahrenheit. Other heating elements may also be relied upon to maintain the temperature inside second tank 20. In addition to maintaining proper temperatures, chart recorder/controller 50 may also serve to record and/or store all events regarding second tank 20 during the brewing process.

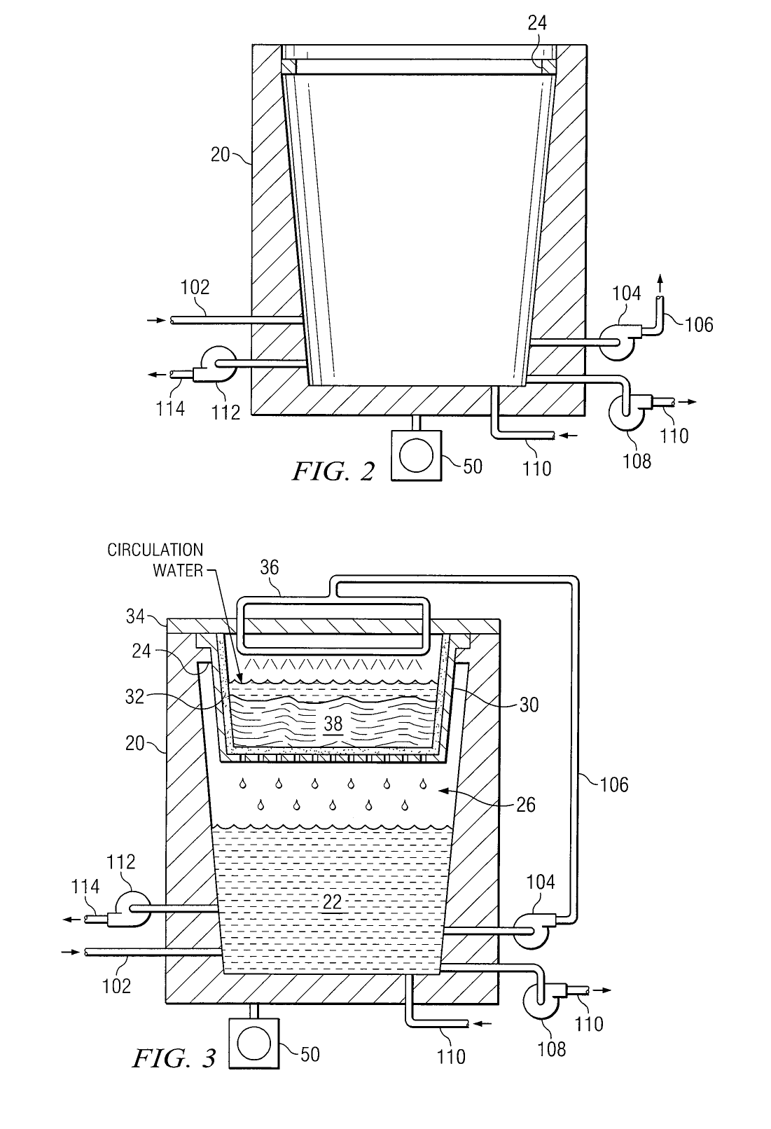

Second tank 20 may also contain pump 104 for circulating water 22 through piping 106 and into brewing receptacle 30. Pump 104 may be any pump adequate for circulating water 22 from the bottom of second tank 20 to brewing receptacle 30. In one particular embodiment, this may require a one horsepower brew pump. Brewing receptacle 30 will be described in more detail below, with reference to FIGS. 2 and 3.

After all the water 22 in second tank 20 has been fully circulated through brewing receptacle 30 to produce a final brewed tea, the brewed tea is transferred out of second tank 20. This may be accomplished using pump 112. Pump 112 may be any pump capable of removing brewed tea from second tank 20 and returning it to first tank 10 through piping 114. In particular embodiments, pump 108 may be a five horsepower transfer pump.

In addition to the elements listed above, second tank 20 may also include all valving and piping necessary for the brewing and transferring of the water and/or brewed tea. While some components are displayed as located external to second tank 20, some or all of the components may be integrated into the design of second tank 20, or even placed inside of second tank 20.

In some embodiments, the brewed tea may also be passed through a filter medium before returning to first tank 10. The filter may vary depending on the amount of filtration desired. In one particular embodiment, a 25 micron sleeve filter may be employed. This filter may be located in piping 114, incorporated into pump 112, or positioned somewhere else in the fluid return path between second tank 20 and first tank 10.

When the brewed tea is returned to the first tank 10, it may still be at a relatively high temperature that may be very close to the brewing temperature. At this point, the brewed tea may be cooled down. As shown in FIG. 1, this may be accomplished by circulating the brewed tea through heat exchanger 60 and returning it to the first tank 10. In the illustrated embodiment, this is accomplished using piping 118 and pump 116. This circulation may be repeated until the liquid has reached a desired temperature. Heat exchanger 60 may be any heat exchanger or comparable cooling device capable of providing the necessary cooling. In some instances, there may be more than one heat exchanger required to provide the necessary cooling. For instance, in one embodiment, the brewed tea will be at a temperature of approximately 198 degrees Fahrenheit, and will be cooled to a temperature of approximately 35 degrees Fahrenheit. In this case, a single heat exchanger may not be capable of producing the 163 degree temperature change, and one or more heat exchangers may be relied upon.

Additionally, different cooling mechanisms may be used. These include, but are not limited to heat exchangers, cooling towers, surge tanks, chillers, ice builders, and other cooling mechanisms. Any combination of the above-listed mechanisms may be employed to provide the necessary cooling requirements.

In the illustrated figure, heat exchanger 60 is located external to the first tank 10. In alternative embodiments, heat exchanger 60 may located inside or incorporated into first tank 10 to provide cooling inside the tank. In embodiments using multiple cooling mechanisms, some mechanisms may be located outside of the first tank 10, while others may be incorporated into or positioned inside of the tank.

After the brewed tea returns to the first tank 10, it will be mixed with the excess water 12 that remained in the first tank. As mentioned earlier, first tank 10 may include an agitating device capable of mixing the brewed tea and water. This device may mix the contents of first tank 10 after the brewed tea has been cooled. Alternatively, this mixing process may occur simultaneously with the cooling process.

The process illustrated by FIG. 1 and/or described above may be repeated until the contents of first tank 10 comprise the desired mixture of brewed tea for consumption. At this point, the brewed tea is tested for various qualities, including color, pH level, Brix level (sweetness), and taste. If the brewed tea passes these tests, it may then be released for bottling.

FIG. 2 illustrates a detailed cross-sectional view of second tank 20 in accordance with an embodiment of the present invention. As described above, second tank 20 receives water from first tank 10 through piping 102. The water in the second tank 20 is then heated to a certain temperature by circulating the liquid through heat exchanger 40 (not pictured). In the illustrated embodiment, pump 108 and piping 110 are used for this circulation process. The heated temperature may then be maintained throughout the brewing process using chart recorder/controller 50. After the liquid is heated, pump 104 circulates the liquid through circulation tubing 106 to brewing receptacle 30. After the brewed tea is returned to second tank 20, it is returned to the first tank 10 through piping 114, using a transfer pump 112.

According to one embodiment, and as shown in FIG. 2, the interior of second tank 20 may have a tapered bottom. This feature may allow more efficient drainage of the liquid in the tank for circulation and transfer purposes.

Additionally, and as shown in FIG. 2, second tank 20 may include brewing cradle 24. Brewing cradle 24 provides support for suspending brewing receptacle 30 within second tank 20 during the brewing process. Brewing cradle 24 may take many forms, including but not limited to railings, pegs, or hooks operable to hold brewing receptacle 30. While one brewing cradle 24 is displayed in FIG. 2, multiple cradles may be employed in alternative embodiments. These could potentially accommodate various brewing receptacles having different sizes, shapes, or weights. Additionally, multiple brewing cradles could allow brewing receptacle 30 to be suspended at varying distances above the liquid in second tank 20 to allow for, among other things, the use of varying volumes of liquid.

FIG. 3 is another, detailed cross-sectional view of second tank 20 in accordance with an embodiment of the present invention. In particular, FIG. 3 illustrates second tank 20 with brewing receptacle 30 installed during a circulation process of the brewing method. As described above, second tank 20 receives water from first tank 10 through piping 102. The water in the second tank 20 may then be heated to a certain temperature by circulating the liquid through heat exchanger 40 (not pictured). In the illustrated embodiment, pump 108 and piping 110 are used for this circulation process. The heated temperature may then be maintained throughout the brewing process using chart recorder/controller 50. After the liquid is heated, pump 104 may circulate the liquid through circulation tubing 106 to brewing receptacle 30. After the brewed tea is returned to second tank 20, it may be returned to the first tank 10 through piping 114, using a transfer pump 112.

The circulation of water from second pump 20 through brewing receptacle 30 is shown with more detail in FIG. 3. Generally, brewing receptacle 30 is placed in brewing cradle 24, covered with diffuser lid 34, and connected to circulation piping 106.

Brewing receptacle 30 may be any receptacle operable to hold tea leaves and facilitate the brewing of tea using system 100. Receptacle 30 may be constructed of various materials that will depend on the specific requirements of other components of brewing system 100. Other considerations include heat conduction, corrosion resistance, and manufacturability of the desired shape of the receptacle. In one particular embodiment, receptacle 30 may be made of a stainless steel, such as 316 stainless steel.

Brewing receptacle 30 may also have a perforated section to allow drainage of the brewed tea. In particular embodiments, this perforated section may be located only along the bottom surface of brewing receptacle 30. In alternative embodiments, the perforated section may extend up one or more sides of the brewing receptacle 30. In the illustrated embodiment, the perforations are round in nature, but it will be appreciated that the perforations could take any shape. The size and number of the perforations may vary, depending on the desired flow rate and the size of the tea leaves or particles that should be prevented from passing through the perforations. In particular embodiments, the perforated section may take on a pattern such that there are 36 holes per square inch.

In particular embodiments, and as shown in FIG. 3, brewing receptacle 30 may have a tapered bottom to facilitate drainage of the brewed tea 26. Brewing receptacle may additionally be configured so that it can be suspended in brew cradle 24. This functionality may take the form of a lip, a series of hooks, or any other feature that will allow the receptacle 30 to rest within brewing cradle 24.

After the water in second tank 20 is properly heated, but before circulation through brewing receptacle 30 has begun, brewing receptacle 30 may be prepared for the brewing process. This is typically performed before brewing receptacle 30 is installed into brewing cradle 24. However, in other particular embodiments, the brewing receptacle 30 may be prepared for the brewing process after it has been installed into brewing cradle 24. In either of these instances, the brewing receptacle 30 may be physically lifted and placed into brewing cradle 24 by, for example, a hoist. For instance, brewing receptacle 30 may have lifting “eye” type hooks for raising and installing the receptacle within brewing cradle 24.

One step of preparing brewing receptacle 30 includes installing a filter 32 into the receptacle. Filter 32 may be selected from a wide range of filters depending on specific factors regarding the brewing process. Factors taken into consideration may include, but are not limited to the size of the perforations in brewing receptacle 30, the size of tea leaves used, the kind of tea leaves used, and the desired consistency of the brewed tea. In one particular embodiment, a 50 micron paper filter may be employed. Regardless of the filter chosen, filter 32 may be installed into receptacle 30 so that it overlaps the perforations of the receptacle. The filter 32 may be specially designed to fit the interior contours of brewing receptacle 30. Alternatively, one or more standard sheets of filter paper may be cut to size to fit inside the receptacle. Depending on the durability of filter 32 chosen, the filter may be used for brewing only a single batch of tea leaves, or it may be used for multiple brewing cycles.

After the appropriate filter 32 is installed in brewing receptacle 30, tea leaves 38 are added to the receptacle 30. Instead of using individual tea bags, the method of the current disclosure relies on loose tea leaves. Tea leaves 38 may be in the form of whole, cut, or even ground tea leaves. In particular embodiments, the loose tea leaves may be finely granulated, with each granule having the approximate size of a grain of salt. The size of tea leaves 38 chosen may depend on the type of tea used and the desired consistency of the final brewed tea.

After filter paper 32 and tea leaves 38 are installed in brewing receptacle 30, and the receptacle is installed in brewing cradle 24, circulation of water from the bottom of second tank 20 through the brewing receptacle 30 may begin. In the embodiment illustrated by FIG. 3, this is accomplished through the use of diffuser lid 34, which includes distribution header 36.

Diffuser lid 34 may include a cover that fits over the top of brewing receptacle 30 during the brewing process. Diffuser lid 34 may be constructed of a wide range of materials. Factors to consider in the selection of the material include the desired strength, weight, and insulation of the lid. In particular embodiments, differ lid 34 is constructed using a stainless steel, such as 316 stainless steel. Diffuser lid 34 may be designed to fit snugly over the top of brewing receptacle 30. In alternative embodiments, diffuser lid 34 may be designed so that it works with various brewing receptacles, each having a different size.

Similar to brewing receptacle 30, diffuser lid 34 may also include some means of lifting the lid for installation purposes. In a particular embodiment, this may take the form of “eye” type hooks for lifting the lid into place using a hoist.

Integrated into diffuser lid 34 is a distribution header 36. Distribution header 36 can be coupled to piping 106 to provide circulation of water from the bottom of second tank 20 through brewing receptacle 30. In the illustrated embodiment, distribution header 36 constitutes a single U-shaped piece of piping running along the inside surface of diffuser lid 34. This portion of distribution header 36 may comprise a plurality of perforations to allow fluid flow into brewing receptacle 30. These perforations may include, but are not limited to dimples, spray nozzles, misters, or other apertures operable to evenly distribute water through brewing receptacle 30. It will be appreciated that different configurations of distribution header 36 and its perforations may be chosen to provide the desired spray characteristics within brewing receptacle 36. Distribution header 36 also includes one or more valves or fittings to connect it to piping 106. This connection may occur inside of brewing receptacle 30. In the illustrated embodiment, this connection is made on the exterior surface of diffuser lid 34.

Once piping 106 is connected to distribution header 36, the circulation of water for the brewing process may begin. This may begin with pump 104 circulating heated water from the bottom of second tank 20 up through piping 106. The water then enters distribution header 36, and is sprayed through the perforations of distribution header into brewing receptacle 30. As the water begins to fill brewing receptacle 30, some of the tea leaves 38 will float, but most of the leaves will remain toward the bottom of the receptacle. As the hot water circulates in and around the tea leaves, a brewed tea will result. Droplets 26 of the brewed tea will slowly pass through filter paper 32 and through the perforated sections of receptacle 30, falling back into second tank 20 where it will mix with the water. The use of loose tea leaves and filter paper will prevent the bunching problems associated with using individual tea bags. In addition, the loose tea leaves may allow for more uniform flow and circulation of water, producing a more uniform, consistent brewed tea.

During the brewing process, it is desirable to maintain the water level in brewing receptacle 30 above the tea leaves but below an overflow level. In order to maintain this level, the flow rate produced by pump 104 must be adjusted to compensate for tea droplets leaving the brewing receptacle 30. In particular embodiments, this flow control may be accomplished through the use of control programming. As the process continues, brewed tea 26 will continue to mix with water 22 in second tank 20. This process will continue until all or substantially all of the liquid in second tank 20 is a brewed tea of the desired consistency. The timing of this circulation process will depend on the amount and kind of tea being brewed, as well as the desired strength and consistency of the tea.

After the circulation process is complete, pump 104 is turned off, and piping 106 is disconnected from distribution header 36 in diffuser lid 34. Diffuser lid 34 may then be removed, using the same method used to install the lid. At this point, some amount of brewed tea will still remain inside of brewing receptacle 30, due to the slow nature of the drip process. Thus, receptacle 30 may remain in place to allow for the remaining brewed tea to pass through the perforations and into second tank 20. At this point, sweeteners and preservatives may also be added to the brewed tea in second tank 20. In particular embodiments, this is accomplished by raising brewing receptacle 30 out of the brewing cradle 24, and adding sweeteners, such as liquid sucrose, and preservatives, such as potassium sorbate, into second tank 20, while brewed tea continues to drip from the brewing receptacle 30. For sweeteners that do not need to be added to a hot liquid to dissolve (particularly artificial sweeteners), they may be added at this point, or may be added to the cooled brewed tea after it is returned to first tank 10.

After substantially all of the brewed tea has flown out of brewing receptacle 30, transfer pump 112 is turned on to transfer the brewed tea back to first tank 10, as previously described. At this point, the used tea leaves 38 may be removed. In some instances, this may be performed manually. Alternatively, and according to a particular embodiment of the present disclosure, brewing receptacle may have a dumping mechanism. This dumping capability may allow the receptacle to be tilted on its side so that the used tea leaves are dumped. The brewing receptacle 30 may then be returned to an upright position and made ready for the next brewing process. Filter paper 32 may also need to be removed before the next brewing process, or it may simply be rinsed of and re-used.

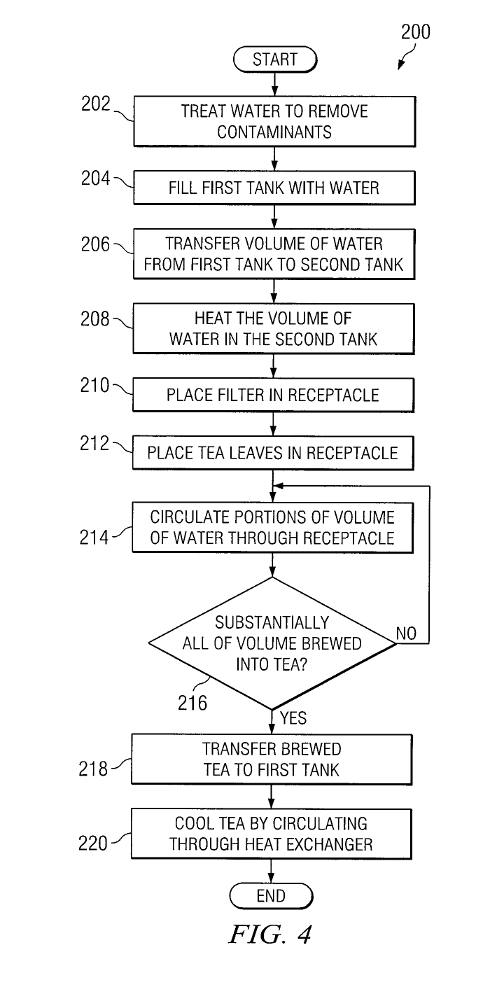

FIG. 4 is a flow diagram illustrating a method 200 of brewing tea according to an embodiment of the present invention. The method begins at step 202, where a predetermined amount of water is treated to remove contaminants such as chlorine or chloramine. At step 204, a first tank is filled with this treated water.

At step 206, a volume of the water in the first tank is transferred to the second tank. As described above with reference to FIG. 1, the volume of water is transferred from first tank 10 to second tank 20 using piping 102. In particular embodiments, a pump may be used to facilitate this transfer.

At step 208, the volume of water that has been transferred to the second tank 20 is heated. In particular embodiments, the water is heated to and maintained at a temperature of approximately 198 degrees Fahrenheit. This heating may be accomplished by circulating the water through a heat exchanger and/or a chart controller/recorder. These and other heating apparatuses may be incorporated within second tank 20, located externally to second tank 20, or some combination thereof.

At step 210, a filter paper 32 may be installed in brewing receptacle 30 to overlap the perforations of the receptacle, as described above with reference to FIG. 3. In particular embodiments, filter paper 32 may be a 50 micron filter paper. Filter paper 32 may be custom sized to fit within the brewing receptacle 30, or alternatively, several sheets of filter paper may be cut to size to fit within the receptacle.

At step 212, tea leaves 38 are added to the receptacle 30. In particular embodiments, loose tea leaves are used. The tea leaves 38 may be whole, cut, ground, finely granulated, or any combination thereof.

At step 214, portions of the volume of water in the second tank 20 are circulated through the brewing receptacle 30. As described above with reference to FIG. 3, the portions may be circulated using pump 104 and piping 106, allowing the portions to flow over and through the tea leaves in receptacle 30. In particular embodiments, a diffusion lid 34 and distribution header 36 may be used to evenly distribute the portions of water over the tea leaves in the receptacle. As the portions of water flow over and through the tea leaves, a brewed tea will result. This brewed tea may pass through filter paper 32 and the perforated sections of the brewing receptacle 30, returning to and mixing with the portion of water in second tank 20.

At step 216, the liquid mixture in second tank 20 is monitored. If portions of the water remain, the circulation of step 212 will be continued. However, after all or substantially all of the volume of liquid in second tank 20 has been brewed into tea, the circulation process may end. As described above with reference to FIG. 3, after circulation has ended, brewed tea may still remain in brewing receptacle 30. Therefore, receptacle 30 may remain in place and be allowed to “drip” until substantially all of the brewed tea has returned to second tank 20.

At step 218, the brewed tea is transferred to the first tank. The brewed tea may then be mixed with a volume of water remaining in the first tank.

At step 220, the volume of brewed tea in first tank 20 is cooled by circulating the liquid through a heat exchanger 60. As described above with reference to FIG. 1, one or more heat exchangers may be employed, depending on the desired temperature difference. Additionally, cooling towers, surge tanks, chillers, or ice builders may be employed. According to particular embodiments, the one or more heat exchangers may cool the brewed tea to a temperature of approximately 35 degrees Fahrenheit.

According to particular embodiments of the current disclosure, a second volume of liquid in the first tank may then be transferred to the second tank 20, and the steps of process 200 may be repeated. This process may be repeated until all or substantially all of the liquid in first tank 10 is a brewed tea.

Although the present invention has been described in detail, it should be understood that various changes, substitutions, and alterations can be made without departing from the spirit and the scope of the invention as defined by the appended claims.

What is claimed is:

1. A method for brewing tea, comprising:
filling a first tank with water;
transferring a volume of the water from the first tank to a second tank;
heating the volume of the water in the second tank;
placing a first plurality of tea leaves in a receptacle, wherein the receptacle is in fluid communication with the second tank; and
circulating portions of the volume of water in the second tank through the receptacle, wherein the portions flow over the tea leaves and return to the second tank, resulting in a brewed tea.

2. The method of claim 1, further comprising:
transferring the brewed tea from the second tank to the first tank; and
cooling the brewed tea using one or more heat exchangers.

3. The method of claim 1, wherein the first plurality of tea leaves comprises loose tea leaves that are free to flow throughout the entire receptacle when the portions of the volume of water are circulated through the receptacle.

4. The method of claim 1, wherein the receptacle comprises a perforated section to allow fluid flow therethrough, and wherein the receptacle is positioned above the volume of water inside the second tank.

5. The method of claim 4, further comprising installing a filter paper inside the receptacle before placing the plurality of tea leaves in the receptacle, such that the filter paper overlaps the perforated section of the receptacle.

6. The method of claim 5, wherein the receptacle further comprises a dumping mechanism capable of removing the first plurality of tea leaves from the receptacle after circulating the portions of the volume of water through the receptacle.

7. The method of claim 1, wherein circulating the portions of the volume of water in the second tank through the receptacle comprises evenly spraying the water into the receptacle using a diffuser mechanism.

8. The method of claim 1, further comprising mixing the brewed tea with the water in the first tank, resulting in a liquid mixture of tea and water.

9. The method of claim 8, further comprising:
transferring a volume of the liquid mixture to the second tank heating the volume of the liquid mixture in the second tank;
placing a second plurality of tea leaves in the receptacle, wherein the receptacle is in fluid communication with the second tank;
circulating portions of the volume of the liquid mixture in the second tank through the receptacle, wherein the portions flow over the tea leaves and return to the second tank, resulting in a brewed tea;
transferring the brewed tea from the second tank to the first tank;
cooling the brewed tea using the one or more heat exchangers; and
mixing the brewed tea with the liquid mixture in the first tank.

10. A system for brewing tea, comprising:
a first tank, operable to store water;
a second tank, operable to receive a volume of the water from the first tank;
a heating element, operable to heat the volume of the water in the second tank;
a receptacle in fluid communication with the second tank, wherein the receptacle is operable to hold a first plurality of tea leaves; and
a first pump, operable to circulate portions of the volume of water in the second tank through the receptacle, wherein the portions flow over the tea leaves and return to the second tank, resulting in a brewed tea.

11. The system of claim 10, further comprising:
a second pump, operable to transfer the brewed tea to the first tank; and
one or more heat exchangers, operable to cool the brewed tea.

12. The system of claim 10, wherein the plurality of tea leaves comprises loose tea leaves that are free to flow throughout the entire receptacle when the portions of the volume of water are circulated through the receptacle.

13. The system of claim 10, wherein the receptacle comprises a perforated section to allow fluid flow therethrough, and wherein the receptacle is positioned above the volume of water inside the second tank.

14. The system of claim 13, further comprising a filter paper installed inside the receptacle before placing the plurality of tea leaves in the receptacle, such that the filter paper overlaps the perforated section of the receptacle.

15. The system of claim 14, wherein the receptacle further comprises a dumping mechanism capable of removing the plurality of tea leaves from the receptacle after circulating the portions of the volume of water through the receptacle.

16. The system of claim 12, further comprising a diffuser mechanism operable to evenly spray the portions of the volume of water from the second tank into the receptacle.

17. The system of claim 12, further comprising a mixer operable to mix the brewed tea with the water in the first tank, resulting in a liquid mixture of tea and water.

18. The system of claim 17, wherein:
the second tank is further operable to receive a volume of the liquid mixture from the first tank;
the heating element is further operable to heat the volume of the liquid mixture in the second tank;
the receptacle is further operable to hold a second plurality of tea leaves; and
the first pump is further operable to circulate portions of the volume of the liquid mixture in the second tank through the receptacle, wherein the portions flow over the tea leaves and return to the second tank, resulting in a brewed tea.
